(19) United States
(12) Patent Application Publication
(10) Pub. No.: US 2014/0021106 A1
(43) Pub. Date: Jan. 23, 2014

(54) Energy Efficient Topsoil Screener

(71) Applicant: Neil Abraham, Middletown, NY (US)

(72) Inventor: Neil Abraham, Middletown, NY (US)

(21) Appl. No.: 13/473,780

(22) Filed: Jul. 23, 2012

(51) Int. Cl. B07B 1/28

(52) U.S. Cl. 209/235

(57) ABSTRACT

The Green Screen is an environmentally friendly way to make topsoil. The Green Screen does not use gas, electricity, air compression or any external power source to operate. The operator simply shovels/moves dirt onto the screen whereby the springs/coils begin to bounce under the weight of the dirt, thus sifting out the topsoil by way of its own movement. The rocks and unwanted materials stay on top of the screen or roll forward, while all the topsoil has been separated out and is ready for distribution.

### CROSS REFERENCE TO RELATED APPLICATIONS

N/A

### BACKGROUND OF THE INVENTION

This machine started simply as a small wood frame I built years ago with a screen fastened over it and two legs to hold it at the proper angle. It produced small amount of topsoil very well but I wanted to make more

When my old pick-up truck fell into disrepair, I kept the ladder rack thinking it must have value. In early 2012, I modified this rack to set on wood posts, added a screen and this worked great. Then when I added a coil spring to each side to increase soil movement, I realized this was a great machine

After using the screener for some time, I want to bring it to the market place. This machine does not use any outside power source such as gas, electric or compressed air to screen the soil; hence “The Green Screen”.

### BRIEF SUMMARY OF THE INVENTION

This portable topsoil screener requires the user shovel/move dirt on to the screen whereby the steel springs do most of the work; bouncing/vibrating up and down and sifting out the topsoil without much additional assistance by the user.

This machine is designed to save money and the environment. By eliminating the necessity of gas, electricity or air compression from the equation, this topsoil screener is better for the environment and the user's bottom line.

### BRIEF DESCRIPTIONS OF THE VIEWS OF THE DRAWING

FIG. 1—

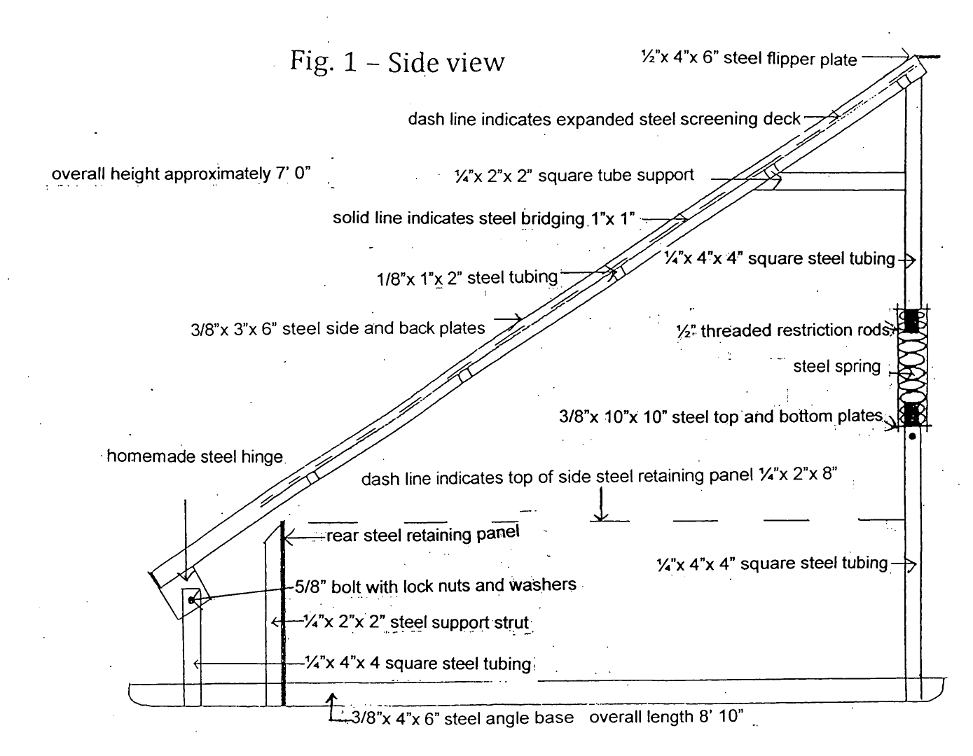

This is the side view of The Green Screen and would be the same on both sides and is labeled accordingly.

FIG. 2—

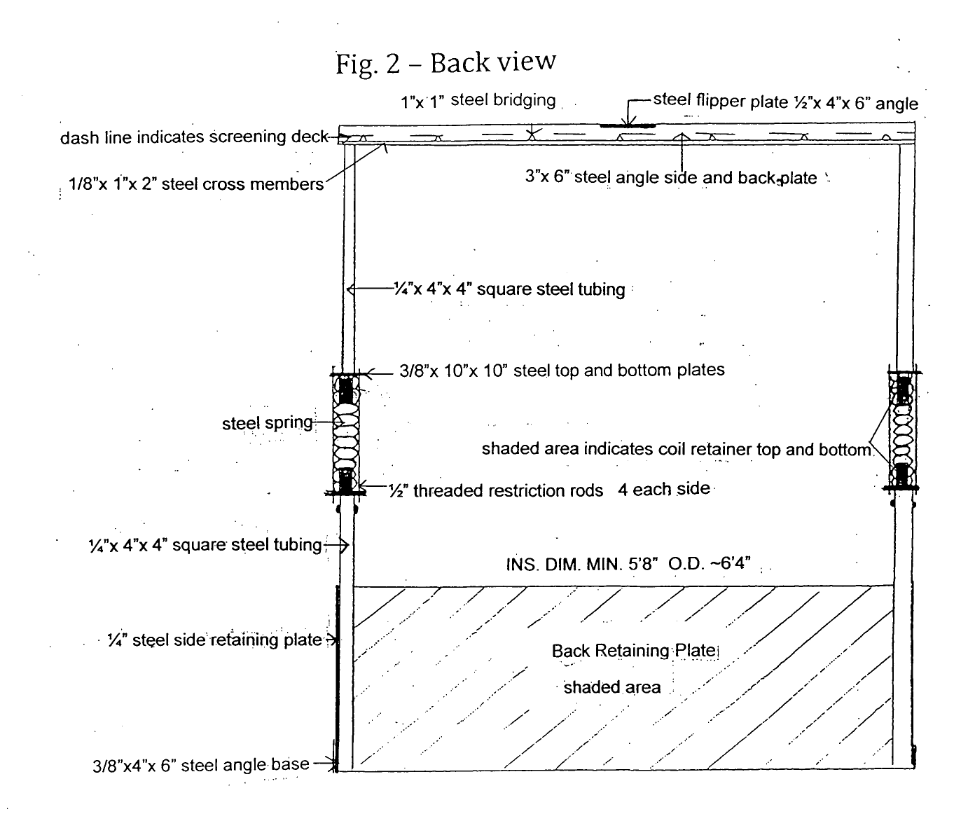

This is the rear view of The Green Screen and is labeled accordingly.

FIG. 3—

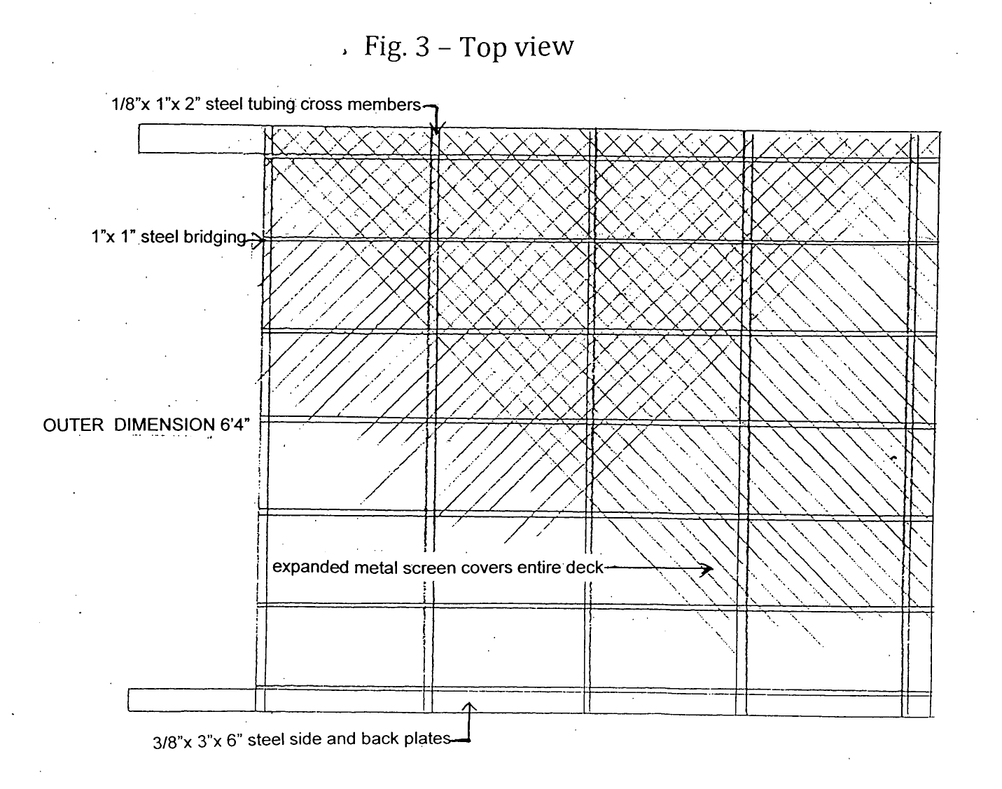

This is the top view of The Green Screen and is labeled accordingly

### DETAILED DESCRIPTION OF THE INVENTION

The Green Screen is a machine that eliminates the need of gas, electricity, or air compression required by typical topsoil screeners. Other topsoil screeners use external power sources to shake/vibrate and sift out the topsoil but The Green Screen uses the force of the dirt being moved on to the screen to sift out the topsoil. Once the dirt is shoveled on to the screen, the steel springs began to bounce up and down, forcing the dirt on top of the metal screen to move around and sift out the topsoil.

It is a portable machine that is simple and effective to use, doesn't require special expertise/knowledge and the risk of injury is de minimis.

1. What I claim as my invention is the use of springs and/or coils to generate the motion necessary to sift out topsoil whereby eliminating the need for outside power sources such as gas, electricity, air compression or any other external power source.
